(19) United States
(12) Patent Application Publication
(10) Pub. No.: US 2023/0205799 A1
(43) Pub. Date: Jun. 29, 2023

(54) PARAMETER OPTIMIZATION IN UNSUPERVISED TEXT MINING

(71) Applicant: Yasar Tekin, Usak (TR)

(72) Inventor: Yasar Tekin, Usak (TR)

(21) Appl. No.: 17/998,810

(22) PCT Filed: May 22, 2020
(86) PCT No.: PCT/TR2020/050440

§ 371 Date: Nov. 15, 2022

(51) Int. Cl. G06F 16/35

(52) U.S. Cl. CPC G06F 16/35

(57) ABSTRACT

The present disclosure provides a method for parameter optimization in unsupervised text mining techniques. The method comprises: a) generating a parameter pool composed of a plurality of parameter vectors; b) generating a model for each parameter vector in the parameter pool; c) calculating pairwise semantic relatedness scores between representative texts in clusters of the models; d) calculating scores of the clusters by averaging the scores of the representative texts; e) calculating scores of the models by averaging the scores of the clusters; f) comparing the scores of the parameter vectors which are the scores of the corresponding models; g) updating the parameter pool; h) repeating the steps b through g until termination condition is met. The method increases the accuracy of the unsupervised text mining techniques by effectively and efficiently optimizing their parameters.

### TECHNICAL FIELD

The present disclosure relates to text mining field, and more particularly relates to a method for parameter optimization in the unsupervised text mining techniques.

### BACKGROUND ART

Text Mining is about discovering patterns from textual data. The techniques used in this field can be grouped in two main categories: supervised and unsupervised. While supervised text mining uses labelled text for training, unsupervised text mining uses unlabelled text.

Performance of a model in an unsupervised text mining technique depends on its parameter settings. The performances of the models generated with different parameter values vary greatly. Despite their broad use in many different fields, the unsupervised text mining techniques have an unresolved problem: how to optimize parameters. Examples of the parameters may include, but are not limited to, the number of topics, a Dirichlet prior on document-topic distributions and a Dirichlet prior on topic-word distributions in Latent Dirichlet Allocation topic model, and the number of clusters in K-means clustering.

Parameter optimization problem prevents the unsupervised text mining techniques from obtaining accurate results. If the parameters are not optimized in an appropriate manner, the results become meaningless and can be effective neither in the intrinsic nor in the extrinsic tasks. Thus, there is a need to develop an effective and efficient method for parameter optimization.

### DETAILED DESCRIPTION

As used herein, the singular forms “a,” “an” and “the” are intended to include the plural forms as well, unless the context clearly indicates otherwise. Additionally, the plural forms are intended to include that the item is one or more, including both singular and plural forms of the term it modifies.

The terms “comprises”, “comprising”, or any other variations thereof, are intended to cover a non-exclusive inclusion, such that a process or method that comprises a list of steps does not include only those steps but may include other steps not expressly listed or inherent to such a process or method.

References throughout this specification to “one embodiment”, “an embodiment”, “another embodiment”, “such embodiment”, “some embodiment”, “an example”, “another example”, “a specific example”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Furthermore, the particular feature, structure, or characteristic may be combined in any suitable manner in one or more embodiments or examples.

Embodiments described and descriptions made in this specification are explanatory, illustrative, and used to make the present disclosure understandable. The embodiments and descriptions shall not be construed to limit the present disclosure. Other embodiments are possible, and modifications and variations can be made to the embodiments without departing from spirit, principles and scope of the present disclosure.

It would also be apparent to one of skill in the relevant art that the embodiments described in this specification can be implemented in many different embodiments of the unsupervised text mining techniques, the optimization techniques and the semantic relatedness measures. Various working modifications can be made to the method in order to implement the inventive concept taught in this specification.

Unless otherwise defined, all technical and scientific terms used in this specification have the same meaning as commonly understood by those skilled in the relevant art to which this disclosure belongs. The system, methods, and examples provided herein are only illustrative and not intended to be limiting.

Embodiments of the present disclosure relate to a method for optimizing parameters in the unsupervised text mining techniques. The method includes the following steps:

At step a, a parameter pool is generated composed of a plurality of parameter vectors. A parameter vector is a collection of parameter values which have the same size with the number of parameters being optimized. A parameter vector may be any kind of collection that has a value for each of the parameters. In some embodiments, parameter vectors may be initialized randomly within a range between the parameters’ predefined minimum and maximum values, while in another embodiment, they may be initialized using a braced initializer list.

At step b, a model is generated with each parameter vector in the pool by using the selected unsupervised text mining technique.

In one embodiment, the technique and the model may be the topic modeling and a topic model respectively, while in another embodiment, they may be the clustering and a cluster model.

Moreover, in one embodiment, the model may be a single model, while in another embodiment, it may be a plurality of replicated models generated with the same parameter vector. Average score of the replicated models may be used as the score of the parameter vector with which the replicated models are generated to alleviate the effects of the model instability.

At step c, the pairwise semantic relatedness scores are calculated between the representative texts in the clusters of the models.

In one embodiment, the cluster may be a topic of a topic model, while in another embodiment, it may be a cluster of a clustering model.

Moreover, in one embodiment, the representative texts may be top words of a topic, while in another embodiment, they may be top n-grams.

Furthermore, in one embodiment, the semantic relatedness score may be calculated by a distributional semantic similarity measure, while in another embodiment, it may be calculated by a knowledge-based semantic similarity measure.

At step d, the scores of the clusters are calculated by averaging the scores of the representative texts. For each cluster, the score is calculated by averaging the scores of its representative texts. In one embodiment, the measure used to average the scores may be the mean, while in another embodiment, it may be the median.

At step e, the scores of the models are calculated by averaging the scores of the clusters. For each model, the score is calculated by averaging the scores of its clusters.

At step f, the scores of the parameter vectors are compared to choose the next candidates. The score of a parameter vector is the score of the model generated with this parameter vector.

In one embodiment, the aim of the comparison may be to select the parameter vectors with higher scores, while in another embodiment, there may also be situations where the parameter vectors with lower scores are selected.

At step g, the parameter pool is updated based on the rules determined by the selected optimization technique. In one embodiment, the rules may be determined by the mutation and crossover strategies of the Differential Evolution algorithm.

At step h, the steps b through g are repeated until the termination condition is met. In one embodiment, the termination condition may be the maximum number of iterations, while in another embodiment, it may be a pre-specified threshold between the best and the worst scores of the parameter vectors.

Additionally, in one embodiment, the method given in this specification may be implemented as a distributed system.

What is claimed is:

1. A method for optimizing parameters in unsupervised text mining techniques, the method comprising:
a) generating a parameter pool composed of a plurality of parameter vectors;
b) generating a model for each parameter vector in the parameter pool;
c) calculating pairwise semantic relatedness scores between representative texts in clusters of the models;
d) calculating scores of the clusters by averaging the scores of the representative texts;
e) calculating scores of the models by averaging the scores of the clusters;
f) comparing the scores of the parameter vectors, which are the scores of the corresponding models;
g) updating the parameter pool; and
h) repeating the steps b through g until termination condition is met.

2. The method of claim 1, wherein the model is a topic model, the cluster is a topic and the representative text is a top word.

3. The method of claim 1, wherein the model comprises a single model or a plurality of replicated models generated with the same parameter vector, the score of which is calculated by averaging the scores of the replicated models.
